(19) United States
(12) Patent Application Publication
(10) Pub. No.: US 2024/0295854 A1
(43) Pub. Date: Sep. 5, 2024

(54) TIMEPIECE

(71) Applicant: SEIKO WATCH KABUSHIKI KAISHA (trading as SEIKO WATCH CORPORATION), Tokyo (JP)

(72) Inventors: Tatsuyuki Sugimoto, Tokyo (JP); Chihiro Funamoto, Tokyo (JP); Yasunori Hara, Tokyo (JP); Yu Ishihara, Tokyo (JP); Kazuhiro Nakayashiki, Tokyo (JP); Koichi Noguchi, Tokyo (JP)

(21) Appl. No.: 18/586,816

(22) Filed: Feb. 26, 2024

(30) Foreign Application Priority Data
Mar. 1, 2023 (JP) 2023-030931

(51) Int. Cl. G04B 3/04

(52) U.S. Cl. CPC G04B 3/043

(57) ABSTRACT

A timepiece includes a case, a dial having a circular plate shape and accommodated in the case, an inner rotating ring formed in a ring shape along an outer peripheral edge of the dial and rotatable in a circumferential direction, a rotation operation unit configured to rotate the inner rotating ring, and a rotation restriction unit configured to restrict an operation of the rotation operation unit. The inner rotating ring includes a plurality of tooth portions. The rotation operation unit includes a rotation shaft portion rotatable around a shaft center along a radial direction of the dial, and a drive transmission gear provided in the rotation shaft portion and meshing with the tooth portions to rotate the inner rotating ring. A plurality of locking portions is formed in the drive transmission gear at different positions in a direction around a shaft. The rotation restriction unit includes a lock receiving portion biased toward the locking portion and detachably locked to the locking portion. The lock receiving portion restricts rotation of the drive transmission gear by being locked to the locking portion.

### RELATED APPLICATIONS

This application claims priority to Japanese Patent application No. JP2023-030931 filed on Mar. 1, 2023, the entire content of which is incorporated herein by reference.

### BACKGROUND OF THE INVENTION

### 1. Field of the Invention

The present invention relates to a timepiece.

### 2. Description of the Related Art

A timepiece including an inner rotating ring rotatable along an outer peripheral edge of a dial is used (see, for example, JP2010-139399A). In the timepiece described in JP2010-139399A, when a rotation operation unit is rotated, a rotational driving force is transmitted to a driving gear of the inner rotating ring, and the inner rotating ring is rotated.

In the timepiece described in JP2010-139399A, an operation feeling when the rotation operation unit is rotated may not be good, and an improvement is required. In the timepiece, the rotation operation unit may rotate due to contact with clothes or the like while a user is not intended to.

### SUMMARY OF THE INVENTION

It is an aspect of the present application to provide a timepiece having an excellent operation feeling and capable of restricting a rotation operation of a rotation operation unit.

(1) A timepiece includes: a case; a dial having a circular plate shape and accommodated in the case; an inner rotating ring formed in a ring shape along an outer peripheral edge of the dial and rotatable in a circumferential direction; a rotation operation unit configured to rotate the inner rotating ring; and a rotation restriction unit configured to restrict an operation of the rotation operation unit, in which the inner rotating ring includes a plurality of tooth portions, the rotation operation unit includes a rotation shaft portion rotatable around a shaft center along a radial direction of the dial, and a drive transmission gear provided on the rotation shaft portion and meshing with the tooth portions to rotate the inner rotating ring, a plurality of locking portions is formed in the drive transmission gear at different positions in a direction around a shaft, the rotation restriction unit includes a lock receiving portion biased toward the locking portion and detachably locked to the locking portion, and the lock receiving portion restricts rotation of the drive transmission gear by being locked to the locking portion.

According to this configuration, the lock receiving portion restricts the rotation of the drive transmission gear by being locked to the locking portion. Therefore, even when a rotational force is applied to the rotation operation unit by contact with clothes or the like, rotation of the rotation operation unit, which is not intended by the user, is less likely to occur.

According to this configuration, when the rotation operation unit is rotated, the plurality of locking portions and the lock receiving portion are locked and unlocked, and thus the user who operates the rotation operation unit obtains a click feeling. Therefore, the operation feeling of the rotation operation unit is improved.

(2) In the timepiece according to (1), the locking portion is formed in a convex shape protruding outward in a radial direction of the drive transmission gear, and the lock receiving portion has a receiving recess to be engaged with the locking portion in a concave-convex manner.

According to this configuration, the click feeling obtained when the locking portion and the lock receiving portion are locked and unlocked is improved. Therefore, the operation feeling of the rotation operation unit is further improved.

(3) In the timepiece according to (1) or (2), the rotation restriction unit further includes a biasing unit configured to bias the lock receiving portion toward the locking portion by a bending elastic force.

According to this configuration, the lock receiving portion can be biased by the biasing unit with an appropriate force. Therefore, it is possible to optimize a rotation restricting force for the rotation operation unit.

(4) In the timepiece according to any one of (1) to (3), the number of the locking portions is the same as that of driving teeth of the drive transmission gear, and the positions of the locking portions in the direction around the shaft are positions corresponding to the driving teeth.

According to this configuration, a position at which the click feeling is generated and a position at which the drive transmission gear is stopped can be made to correspond to each other. Therefore, a deviation does not occur between the position at which the click feeling is generated and a position of the inner rotating ring, and the operation feeling can be improved.

(5) In the timepiece according to (1), the locking portion is a flat portion formed on the drive transmission gear, and the lock receiving portion is locked to the flat portion by surface contact.

According to this configuration, the locking portion and the lock receiving portion are locked by surface contact, and thus an excessive force does not act on the locking portion and the lock receiving portion. Therefore, durability of the rotation operation unit and the rotation restriction unit can be enhanced.

(6) In the timepiece according to (1), the locking portions are driving teeth formed on the drive transmission gear to mesh with the tooth portions of the inner rotating ring, and the lock receiving portion is engaged with the driving teeth in a concave-convex manner.

According to this configuration, the drive transmission gear and the lock receiving portion have simple structures, and thus it is advantageous in terms of miniaturization and reducing manufacturing costs.

### Advantageous Effects of Invention

According to one aspect of the present application, it is possible to provide a timepiece having an excellent operation feeling and capable of restricting a rotation operation of a rotation operation unit.

### BRIEF DESCRIPTION OF THE DRAWINGS

FIG. 1 is a cross-sectional view of a timepiece according to a first embodiment.

FIG. 2 is a cross-sectional view illustrating a part of the timepiece according to the first embodiment.

FIG. 3 is an enlarged cross-sectional view of the timepiece according to the first embodiment.

FIG. 4 is a perspective view illustrating an internal structure of the timepiece according to the first embodiment.

FIG. 5 is an enlarged perspective view illustrating the internal structure of the timepiece according to the first embodiment.

FIG. 6 is an exploded perspective view illustrating a rotation operation unit and a rotation restriction unit of the timepiece according to the first embodiment.

FIG. 7 is a perspective view illustrating the rotation operation unit and the rotation restriction unit of the timepiece according to the first embodiment.

FIG. 8 is an exploded perspective view illustrating a rotation operation unit and a rotation restriction unit of a timepiece according to a second embodiment.

FIG. 9 is a perspective view illustrating the rotation operation unit and the rotation restriction unit of the timepiece according to the second embodiment.

FIG. 10 is a perspective view illustrating a rotation operation unit and a rotation restriction unit of a timepiece according to a third embodiment.

FIG. 11 is a perspective view illustrating a rotation operation unit and a rotation restriction unit of a timepiece according to a fourth embodiment.

### DETAILED DESCRIPTION OF THE PREFERRED EMBODIMENTS

Hereinafter, embodiments of the invention will be described with reference to the drawings.

### First Embodiment

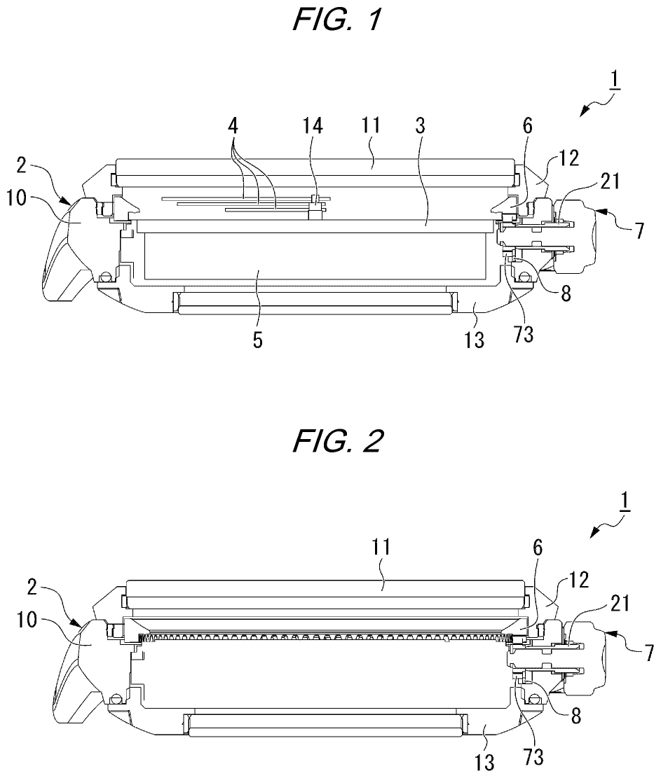

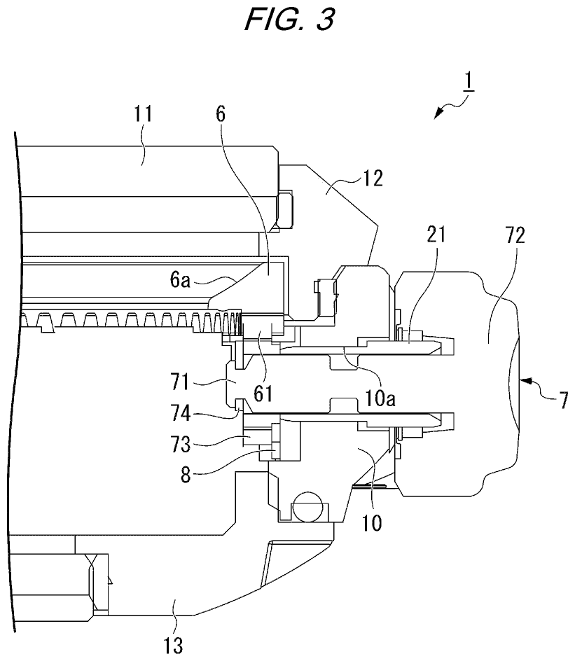

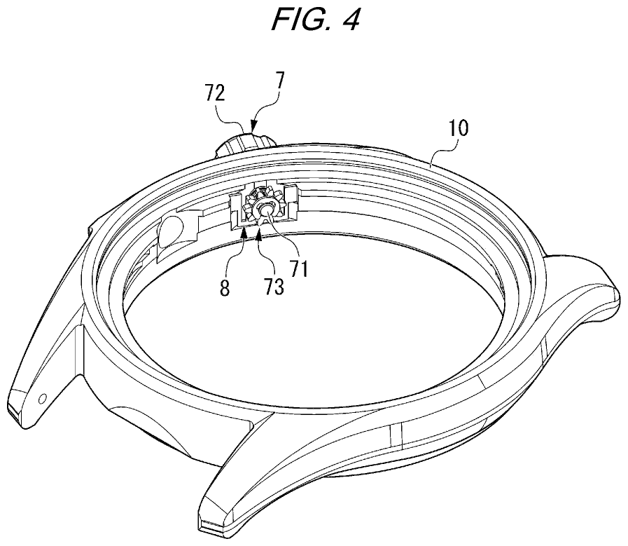

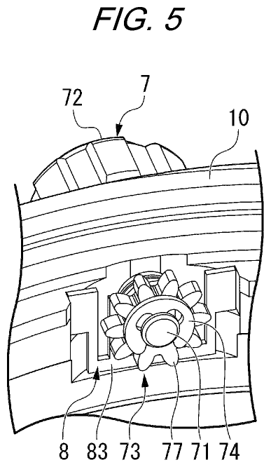

FIG. 1 is a cross-sectional view of a timepiece 1 according to a first embodiment. FIG. 2 is a cross-sectional view illustrating a part of the timepiece 1. FIG. 3 is an enlarged cross-sectional view of the timepiece 1. FIG. 4 is a perspective view illustrating an internal structure of the timepiece 1. FIG. 5 is an enlarged perspective view illustrating the internal structure of the timepiece 1.

As illustrated in FIG. 1, the timepiece 1 according to the first embodiment includes a timepiece case 2, a dial 3, hands 4, a timepiece movement 5, an inner rotating ring 6, a rotation operation unit 7, and a rotation restriction unit 8.

The timepiece case 2 (case) includes a case main body 10, a windshield glass 11, a bezel 12, and a case back 13. The case main body 10 is formed in a cylindrical shape. The windshield glass 11 closes one opening of the case main body 10. The bezel 12 is provided at one opening end of the case main body 10. The bezel 12 holds the windshield glass 11. The case back 13 closes the other opening of the case main body 10. The timepiece case 2 accommodates the dial 3, the hands 4, and the movement 5.

Hereinafter, positions and the like of components are temporarily determined with reference to FIG. 1. For example, the windshield glass 11 is located above the case back 13. The positions and the like illustrated here do not limit postures of the timepiece 1 during use.

The dial 3 is formed in a circular plate shape. The dial 3 is visible through the windshield glass 11.

The hands 4 are disposed between the dial 3 and the windshield glass 11. The hands 4 are attached to a rotation shaft 14 of the movement 5. The movement 5 is disposed between the dial 3 and the case back 13. The movement 5 includes a drive source that drives the rotation shaft 14, and the like. The rotation shaft 14 extends from a center of the dial 3 in a direction orthogonal to the dial 3.

As illustrated in FIG. 2, the inner rotating ring 6 is formed in a ring shape along an outer peripheral edge of the dial 3. The inner rotating ring 6 is formed in a circular ring shape about the rotation shaft 14. The inner rotating ring 6 is rotatable in a circumferential direction. The “circumferential direction” is a direction along a circumference about the rotation shaft 14. A “main radial direction” is a radial direction of the dial 3.

As illustrated in FIG. 3, an information display surface 6a, which is a region including an inner peripheral edge in an upper surface of the inner rotating ring 6 (a surface on a windshield glass 11 side), is an inclined surface descending inward in the main radial direction. Information display can be formed on the information display surface 6a by characters, symbols, graphics, or the like. Examples of the information display include an orientation display indicator. In the timepiece 1, an orientation can be easily measured using the orientation display indicator. The information display is not limited to the orientation display indicator, and may be a date or the like.

A plurality of tooth portions 61 arranged in the circumferential direction is formed on a lower surface of the inner rotating ring 6 (a surface on a case back 13 side). The tooth portions 61 protrude downward from the lower surface of the inner rotating ring 6.

An operation hole 10a is formed in the case main body 10. The operation hole 10a penetrates the case main body 10 along the main radial direction. A support tube 21 is provided in the operation hole 10a.

The rotation operation unit 7 includes a rotation shaft portion 71, a head portion 72, and a drive transmission gear 73.

The rotation shaft portion 71 is inserted into the support tube 21. The rotation shaft portion 71 is rotatable about a shaft center along the main radial direction. A direction around the rotation shaft portion 71 is referred to as a “direction around the shaft”.

The head portion 72 is formed on an outer end portion of the rotation shaft portion 71. The head portion 72 is integrally formed with the rotation shaft portion 71. The head portion 72 has an outer diameter larger than an outer diameter of the rotation shaft portion 71. The head portion 72 is located outside the case main body 10.

As illustrated in FIGS. 4 and 5, the drive transmission gear 73 is attached to the rotation shaft portion 71 by an attachment member 74 such as a C ring. The drive transmission gear 73 rotates integrally with the rotation shaft portion 71 in the direction around the shaft. The drive transmission gear 73 is located on an inner side of the case main body 10.

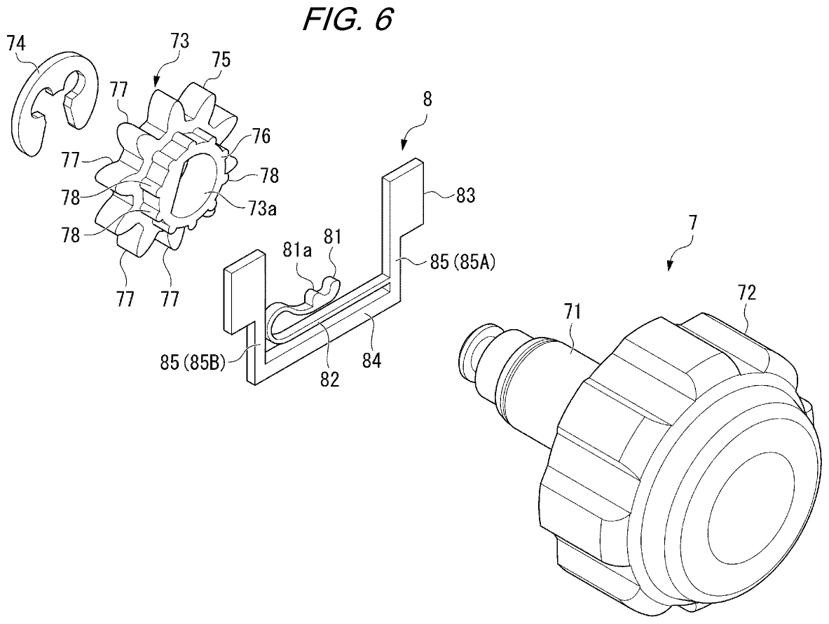

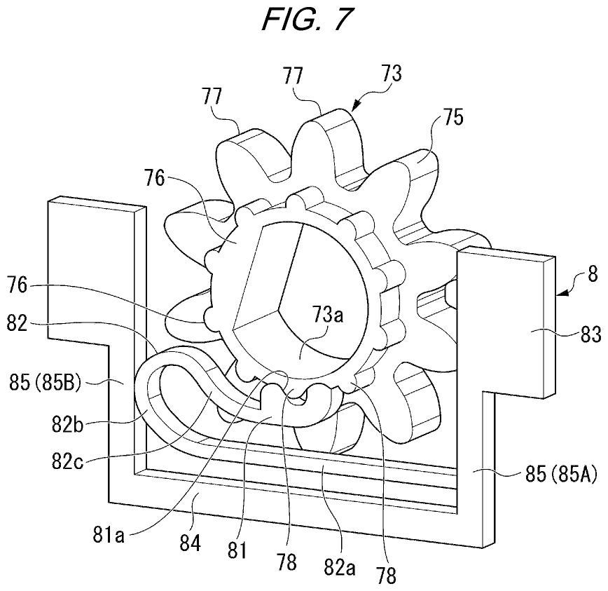

FIG. 6 is an exploded perspective view of the rotation operation unit 7 and the rotation restriction unit 8. FIG. 7 is a perspective view of the rotation operation unit 7 and the rotation restriction unit 8.

As illustrated in FIGS. 6 and 7, the drive transmission gear 73 includes a main portion 75 and a central protrusion 76. The main portion 75 is formed in a plate shape orthogonal to the shaft center of the rotation shaft portion 71. A plurality of driving teeth 77 arranged in the direction around the shaft is formed on an outer peripheral edge of the main portion 75. The plurality of driving teeth 77 is formed at different positions in the direction around the shaft. The driving teeth 77 can mesh with the tooth portions 61 of the inner rotating ring 6. The drive transmission gear 73 rotates the inner rotating ring 6 in the circumferential direction by the driving teeth 77 meshing with the tooth portions 61.

The central protrusion 76 protrudes outward (outward in the main radial direction) from an outer surface of the main portion 75. The central protrusion 76 is a protrusion formed by thickening a portion including a center of the main portion 75. The central protrusion 76 has a substantially circular shape concentric with the main portion 75. The central protrusion 76 has a diameter smaller than a diameter of the main portion 75.

A plurality of locking portions 78 is formed on an outer peripheral surface of the central protrusion 76. The locking portion 78 is formed, for example, in a convex shape protruding outward in the radial direction of the drive transmission gear 73 from the outer peripheral surface of the central protrusion 76. The locking portion 78 is formed, for example, in a convex shape such as an arc shape (for example, a semicircular shape). The shape of the locking portion 78 is not limited to the arc shape, and may be a polygonal shape, an inverted V shape, or the like.

The plurality of locking portions 78 is formed on the outer peripheral surface of the central protrusion 76 at different positions in the direction around the shaft. The plurality of locking portions 78 is formed, for example, at intervals in the direction around the shaft. The plurality of locking portions 78 is formed, for example, at equal intervals in the direction around the shaft.

The number of the locking portions 78 is, for example, the same as that of the driving teeth 77. The positions of the locking portions 78 in the direction around the shaft are preferably positions corresponding to the driving teeth 77. In the present embodiment, the positions of the locking portions 78 in the direction around the shaft coincide with the positions of the driving teeth 77 in the direction around the shaft.

When the positions of the locking portions 78 in the direction around the shaft are the positions corresponding to the driving teeth 77, a position at which a click feeling is generated and a position at which the drive transmission gear 73 is stopped can be made to correspond to each other. Therefore, a deviation does not occur between the position at which the click feeling is generated and a position of the inner rotating ring 6, and an operation feeling can be improved.

An insertion hole 73a through which the rotation shaft portion 71 is inserted is formed at a center of the drive transmission gear 73. The insertion hole 73a is formed in a non-circular shape such as a notched circular shape. The insertion hole 73a is formed at the center of the drive transmission gear 73, so that the drive transmission gear 73 can be penetrated in a thickness direction.

The rotation restriction unit 8 includes a lock receiving portion 81, a biasing unit 82, and a support portion 83. The rotation restriction unit 8 can restrict an operation of the rotation operation unit 7. The rotation restriction unit 8 is formed in a plate shape orthogonal to the shaft center of the rotation shaft portion 71.

The support portion 83 includes a base portion 84 and a pair of extension portions 85. The base portion 84 is formed in a linear shape. The pair of extension portions 85 extend upward from one end portion of the base portion 84 and the other end portion of the base portion 84, respectively. The pair of extension portions 85 face each other at an interval. A direction in which the pair of extension portions 85 are arranged is referred to as a width direction. One of the pair of extension portions 85 is an extension portion 85A. The other extension portion 85 is an extension portion 85B.

The biasing unit 82 is, for example, an extending piece formed integrally with the support portion 83. The biasing unit 82 is elastically bendable and deformable. The biasing unit 82 extends from an inner edge of one extension portion 85 in a direction approaching the other extension portion 85, and has a folded shape.

Specifically, the biasing unit 82 includes a straight portion 82a, a curve folded portion 82b, and an extension portion 82c. The straight portion 82a linearly extends from an inner edge of the extension portion 85A in a direction approaching the extension portion 85B while in parallel to the base portion 84, and reaches a position close to the extension portion 85B. The curve folded portion 82b extends from a tip end of the straight portion 82a while being curved upward in a substantially semicircular shape. The extension portion 82c extends from a tip end of the curve folded portion 82b in a direction approaching the extension portion 85A while gently descending, and reaches the lock receiving portion 81 near a center of the support portion 83 in the width direction.

The lock receiving portion 81 may have, for example, an oval shape, a rectangular shape, or an elliptical shape. In the present embodiment, the lock receiving portion 81 has an oval shape with a long axis direction along the width direction. For example, the lock receiving portion 81 is integrally formed with the biasing unit 82 at a tip end portion of the biasing unit 82. The lock receiving portion 81 is located substantially at the center of the support portion 83 in the width direction.

A receiving recess 81a is formed at an upper edge of the lock receiving portion 81. The receiving recess 81a can be engaged with the locking portion 78 in a concave-convex manner. The receiving recess 81a is an arc-shaped (for example, semicircular) recess capable of receiving the locking portion 78. The lock receiving portion 81 is locked to the locking portion 78 by the receiving recess 81a being engaged with the locking portion 78 in a concave-convex manner. The lock receiving portion 81 is detachably (lockable and unlockable) locked to the locking portion 78.

The lock receiving portion 81 is movable in an upper-lower direction. The lock receiving portion 81 is locked to the locking portion 78 by being raised. The lock is unlocked by lowering the lock receiving portion 81. The lock receiving portion 81 is biased upward (in a direction approaching the locking portion 78) due to bending elasticity of the biasing unit 82.

The lock receiving portion 81 restricts rotation of the drive transmission gear 73 by being locked to the locking portion 78. Specifically, a rotational torque of the drive transmission gear 73 when the lock receiving portion 81 is locked to the locking portion 78 is larger than that when the lock receiving portion 81 is not locked to the locking portion 78. Therefore, even when a rotational force is applied to the head portion 72 by contact with clothes or the like, rotation of the rotation operation unit 7, which is not intended by a user, is less likely to occur.

The lock receiving portion 81 does not completely prevent the rotation of the drive transmission gear 73. When a rotational torque equal to or greater than a predetermined value is applied, the rotation operation unit 7 rotates in the direction around the shaft. Specifically, when the rotational torque equal to or greater than the predetermined value is applied to the rotation operation unit 7, the locking portion 78 presses down the lock receiving portion 81, and the lock between the lock receiving portion 81 and the locking portion 78 is unlocked. Accordingly, the rotation operation unit 7 is in a rotatable state. Therefore, the rotation operation unit 7 is rotatable in the direction around the shaft as the user intends.

Materials forming the rotation operation unit 7 and the rotation restriction unit 8 are not particularly limited. The rotation operation unit 7 and the rotation restriction unit 8 are made of, for example, resin or metal.

In the timepiece 1 according to the present embodiment, the locking portion 78 is formed in the drive transmission gear 73. The rotation restriction unit 8 includes the lock receiving portion 81. The lock receiving portion 81 restricts the rotation of the drive transmission gear 73 by being locked to the locking portion 78. Therefore, even when a rotational force is applied to the head portion 72 by contact with clothes or the like, rotation of the rotation operation unit 7, which is not intended by a user, is less likely to occur.

In the timepiece 1, when the rotation operation unit 7 is rotated, the plurality of locking portions 78 and the lock receiving portion 81 are locked and unlocked, and thus the user who operates the rotation operation unit 7 obtains the click feeling. Therefore, the operation feeling of the rotation operation unit 7 is improved.

The rotation operation unit 7 and the rotation restriction unit 8 have a small number of components, and thus it is possible to save space inside the timepiece 1.

The lock receiving portion 81 includes the receiving recess 81a locked to the locking portion 78 by concave-convex engagement. Therefore, the click feeling obtained when the locking portion 78 and the lock receiving portion 81 are locked and unlocked is improved. Therefore, the operation feeling of the rotation operation unit 7 is further improved.

The rotation restriction unit 8 includes the biasing unit 82 that biases the lock receiving portion 81 by a bending elastic force. Therefore, the lock receiving portion 81 can be biased with an appropriate force. Therefore, it is possible to optimize a rotation restricting force for the rotation operation unit 7.

### Second Embodiment

A timepiece according to a second embodiment will be described. The same components as those according to the first embodiment are denoted by the same reference numerals, and the description thereof is omitted.

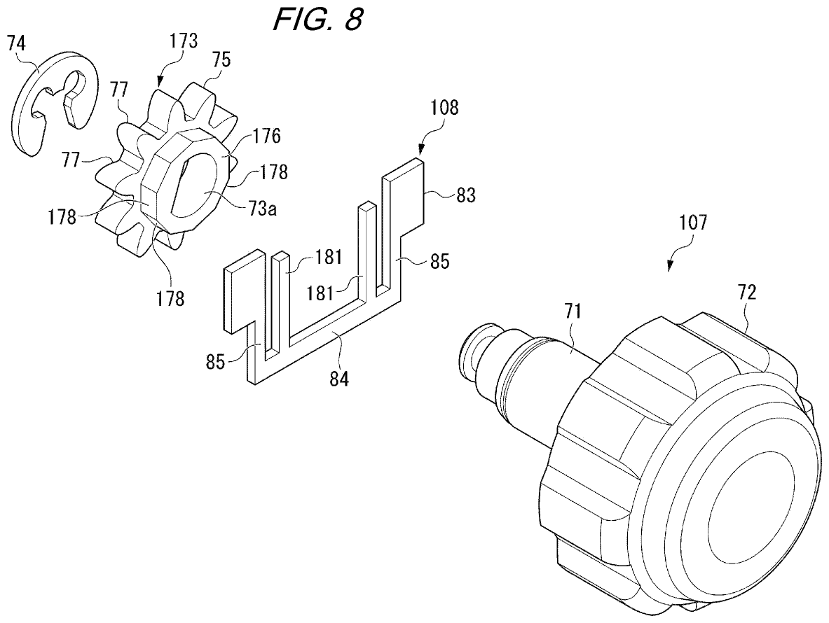

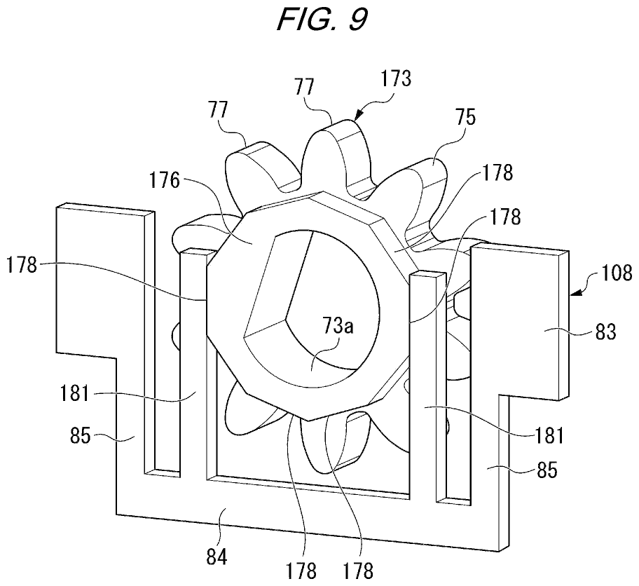

FIG. 8 is an exploded perspective view of a rotation operation unit 107 and a rotation restriction unit 108. FIG. 9 is a perspective view of the rotation operation unit 107 and the rotation restriction unit 108.

As illustrated in FIGS. 8 and 9, the timepiece according to the present embodiment uses the rotation operation unit 107 instead of the rotation operation unit 7. The rotation restriction unit 108 is used instead of the rotation restriction unit 8. The timepiece according to the second embodiment differs from the timepiece 1 according to the first embodiment in these aspects.

The rotation operation unit 107 includes a drive transmission gear 173 instead of the drive transmission gear 73. The drive transmission gear 173 includes the main portion 75 and a central protrusion 176. The central protrusion 176 protrudes outward (outward in a main radial direction) from an outer surface of the main portion 75.

A plurality of locking portions 178 is formed on an outer peripheral surface of the central protrusion 176. The locking portions 178 are flat portions formed on the outer circumferential surface of the central protrusion 176. The locking portions 178 form a flat surface perpendicular to a radial direction of the drive transmission gear 173. The plurality of locking portions 178 is formed on the outer peripheral surface of the central protrusion 176 at different positions in the direction around the shaft. In the present embodiment, eight locking portions 178 having the same shape are arranged in the direction around the shaft on the outer peripheral surface of the central protrusion 176. Therefore, when viewed in a thickness direction of the drive transmission gear 173, the central protrusion 176 has a regular octagonal shape.

The number of the locking portions 178 is, for example, the same as that of the driving teeth 77. The positions of the locking portions 178 in the direction around the shaft are preferably positions corresponding to the driving teeth 77. When the positions of the locking portions 178 in the direction around the shaft are the positions corresponding to the driving teeth 77, a position at which a click feeling is generated and a position at which the drive transmission gear 173 is stopped can be made to correspond to each other. Therefore, a deviation does not occur between the position at which the click feeling is generated and a position of the inner rotating ring 6, and an operation feeling can be improved.

The rotation restriction unit 108 includes a pair of lock receiving portions 181 and the support portion 83. The rotation restriction unit 108 can restrict an operation of the rotation operation unit 107. The rotation restriction unit 108 is formed in a plate shape orthogonal to a shaft center of the rotation shaft portion 71.

The pair of lock receiving portions 181 extend upward from the base portion 84, respectively. The pair of lock receiving portions 181 face each other at an interval. Surfaces of the pair of lock receiving portions 181 that face each other are referred to as inner surfaces. A direction in which the pair of lock receiving portions 181 approach each other is referred to as an inward direction. A direction in which the pair of lock receiving portions 181 separate from each other is referred to as an outward direction. The lock receiving portions 181 are elastically bendable and deformable in the inward direction and the outward direction. When coming into contact with the drive transmission gear 173, the lock receiving portions 181 are biased in the inward direction due to bending elasticity thereof.

The inner surfaces of the lock receiving portions 181 are formed in a flat manner. The lock receiving portions 181 are detachably (lockable and unlockable) locked to the locking portions 178 by surface contact. The lock receiving portions 181 are locked to the locking portions 178 by a movement in the inward direction. The lock is unlocked by bending and deforming the lock receiving portions 181 in the outward direction.

The lock receiving portions 181 restrict rotation of the drive transmission gear 173 by being locked to the locking portions 178. Specifically, a rotational torque of the drive transmission gear 173 when the lock receiving portions 181 are locked to the locking portions 178 is larger than that when the lock receiving portions 181 are not locked to the locking portions 178. Therefore, even when a rotational force is applied to the head portion 72 by contact with clothes or the like, rotation of the rotation operation unit 107, which is not intended by a user, is less likely to occur.

The lock receiving portions 181 do not completely prevent the rotation of the drive transmission gear 173. When a rotational torque equal to or greater than a predetermined value is applied, the rotation operation unit 107 rotates in the direction around the shaft. Specifically, when the rotational torque equal to or greater than the predetermined value is applied to the rotation operation unit 107, the lock receiving portions 181 are moved in the outward direction of the locking portions 178, and the lock between the lock receiving portions 181 and the locking portions 178 is unlocked. Accordingly, the rotation operation unit 107 is in a rotatable state. Therefore, the rotation operation unit 107 is rotatable in the direction around the shaft as the user intends.

In the timepiece according to the present embodiment, the locking portions 178 are formed in the drive transmission gear 173. The rotation restriction unit 108 includes the lock receiving portions 181. The lock receiving portions 181 restrict the rotation of the drive transmission gear 173 by being locked to the locking portions 178. Therefore, even when a rotational force is applied to the head portion 72 by contact with clothes or the like, rotation of the rotation operation unit 107, which is not intended by a user, is less likely to occur.

In the timepiece according to the present embodiment, when the rotation operation unit 107 is rotated, the user obtains the click feeling by locking and unlocking the plurality of locking portions 178 and the lock receiving portions 181. Therefore, the operation feeling of the rotation operation unit 107 is improved.

The rotation operation unit 107 and the rotation restriction unit 108 have a small number of components, and thus it is possible to save space inside the timepiece.

In the timepiece according to the present embodiment, the locking portions 178 and the lock receiving portions 181 are locked by surface contact, and thus an excessive force does not act on the locking portions 178 and the lock receiving portions 181. Therefore, durability of the rotation operation unit 107 and the rotation restriction unit 108 can be enhanced.

### Third Embodiment

A timepiece according to a third embodiment will be described. The same components as those according to other embodiments are denoted by the same reference numerals, and the description thereof is omitted.

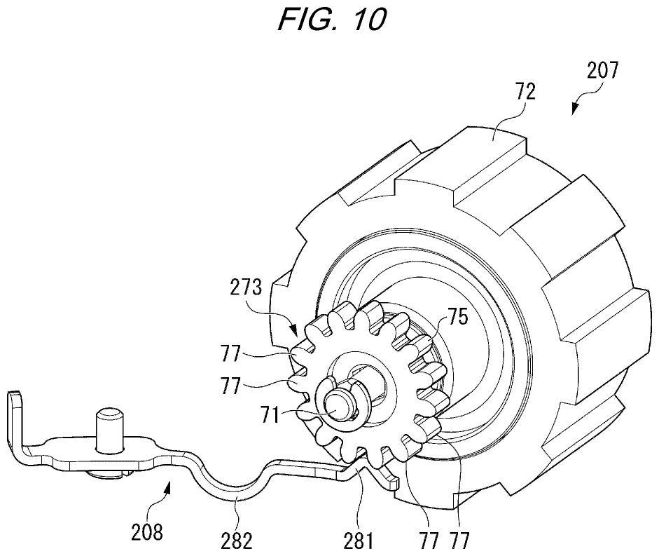

FIG. 10 is a perspective view of the rotation operation unit 207 and the rotation restriction unit 208. As illustrated in FIG. 10, the timepiece according to the present embodiment uses a drive transmission gear 273 instead of the drive transmission gear 73. A rotation restriction unit 208 is used instead of the rotation restriction unit 8. The timepiece according to the third embodiment differs from the timepiece 1 according to the first embodiment in these aspects.

The drive transmission gear 273 is different from the drive transmission gear 73 (see FIG. 6) in the first embodiment in that there is no central protrusion 76 and only the main portion 75 is provided. The driving teeth 77 function as locking portions.

The rotation restriction unit 208 includes an arm 282 including a lock receiving portion 281. The arm 282 is elastically bendable and deformable. The lock receiving portion 281 can be engaged with the driving teeth 77 in a concave-convex manner. The lock receiving portion 281 is formed by bending a part of the arm 282 into a convex shape. The lock receiving portion 281 protrudes in a direction approaching the drive transmission gear 273. A part of the lock receiving portion 281 can enter between the adjacent driving teeth 77. Accordingly, the lock receiving portion 281 is locked to the driving teeth 77.

The lock receiving portion 281 is movable in an upper-lower direction. The lock receiving portion 281 is locked to the driving teeth 77 by being raised. The lock is unlocked by lowering the lock receiving portion 281. The lock receiving portion 281 is biased upward (in a direction approaching the driving teeth 77) due to bending elasticity of the arm 282.

The lock receiving portion 281 restricts rotation of the drive transmission gear 273 by being locked to the driving teeth 77. Specifically, a rotational torque of the drive transmission gear 273 when the lock receiving portion 281 is locked to the driving teeth 77 is larger than that when the lock receiving portion 281 is not locked to the driving teeth 77. Therefore, even when a rotational force is applied to the head portion 72 by contact with clothes or the like, rotation of a rotation operation unit 207, which is not intended by a user, is less likely to occur.

The lock receiving portion 281 does not completely prevent the rotation of the drive transmission gear 273. When a rotational torque equal to or greater than a predetermined value is applied, the rotation operation unit 207 rotates in the direction around the shaft. Specifically, when the rotational torque equal to or greater than the predetermined value is applied to the rotation operation unit 207, the driving teeth 77 press down the lock receiving portion 281, and the lock between the lock receiving portion 281 and the driving teeth 77 is unlocked. Accordingly, the rotation operation unit 207 is in a rotatable state. Therefore, the rotation operation unit 207 is rotatable in the direction around the shaft as the user intends.

In the timepiece according to the present embodiment, the drive transmission gear 273 is formed with the driving teeth 77 functioning as the locking portions. The rotation restriction unit 208 includes the lock receiving portion 281. The lock receiving portion 281 restricts the rotation of the drive transmission gear 273 by being locked to the driving teeth 77. Therefore, even when a rotational force is applied to the head portion 72 by contact with clothes or the like, rotation of the rotation operation unit 207, which is not intended by a user, is less likely to occur.

In the timepiece according to the present embodiment, when the rotation operation unit 207 is rotated, the plurality of driving teeth 77 and the lock receiving portion 281 are locked and unlocked, and thus the user who operates the rotation operation unit 207 obtains a click feeling. Therefore, an operation feeling of the rotation operation unit 207 is improved.

The rotation operation unit 207 and the rotation restriction unit 208 have a small number of components, and thus it is possible to save space inside the timepiece.

In the timepiece according to the present embodiment, the drive transmission gear 273 and the lock receiving portion 281 have simple structures, and thus it is advantageous in terms of miniaturization and reducing manufacturing costs.

### Fourth Embodiment

A timepiece according to a fourth embodiment will be described. The same components as those according to other embodiments are denoted by the same reference numerals, and the description thereof is omitted.

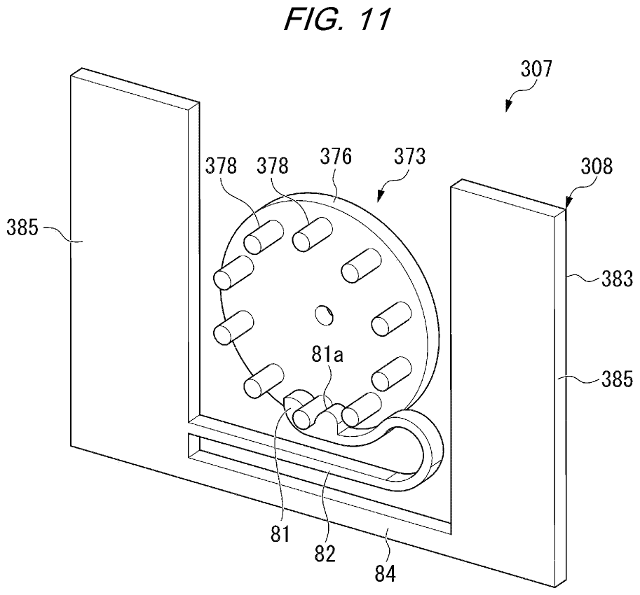

FIG. 11 is a perspective view of a rotation operation unit 307 and a rotation restriction unit 308.

As illustrated in FIG. 11, a drive transmission gear 373 includes a circular central protrusion 376 instead of the central protrusion 76 of the drive transmission gear 73 (see FIG. 7). In FIG. 11, the main portion 75 (see FIG. 7) is not illustrated.

A plurality of locking portions 378 is formed on the central protrusion 376. The locking portions 378 are formed in a cylindrical shape. The locking portions 378 protrude outward (outward in a main radial direction) from an outer surface of the central protrusion 376. The plurality of locking portions 378 is formed, for example, at equal intervals in the direction around the shaft. The locking portions 378 may be rollers rotatable about a central shaft along a shaft center. When the locking portions 378 are rollers, friction with the lock receiving portion 81 can be reduced.

The rotation restriction unit 308 includes the lock receiving portion 81, the biasing unit 82, and a support portion 383. The support portion 383 includes the base portion 84 and a pair of extension portions 385.

The receiving recess 81a of the lock receiving portion 81 can be engaged with the locking portion 378 in a concave-convex manner. The lock receiving portion 81 is detachably (lockable and unlockable) locked to the locking portion 378.

In the timepiece according to the present embodiment, as in the timepiece 1 according to the first embodiment, even when a rotational force is applied to the head portion 72, rotation of the rotation operation unit 307, which is not intended by a user, is less likely to occur. In the timepiece according to the present embodiment, a click feeling is generated when the rotation operation unit 307 is rotated, and thus an operation feeling of the rotation operation unit 307 is improved.

The present invention is not limited to the embodiments described above with reference to the drawings, and various modifications are conceivable within the technical scope of the invention.

For example, in the rotation operation unit 7 and the rotation restriction unit 8 illustrated in FIG. 7, the locking portions 78 are formed in a convex shape, and the receiving recess 81a is formed on the lock receiving portion 81, but structures of the rotation operation unit and the rotation restriction unit are not limited thereto. For example, the locking portion may be a recess, and a protruding portion to be engaged with the locking portion may be formed in the lock receiving portion.

In the timepiece according to the embodiments, the tooth portions that mesh with the drive transmission gear are formed on a lower surface of the inner rotating ring. Alternatively, the tooth portions of the inner rotating ring are not limited to the case of being formed on the lower surface of the inner rotating ring, and may be formed on an inner peripheral surface or an outer peripheral surface of the inner rotating ring.

The timepiece according to the embodiments may be a mechanical timepiece or a quartz timepiece.

What is claimed is:

1. A timepiece comprising:
a case;
a dial having a circular plate shape and accommodated in the case;
an inner rotating ring formed in a ring shape along an outer peripheral edge of the dial and rotatable in a circumferential direction;
a rotation operation unit configured to rotate the inner rotating ring; and
a rotation restriction unit configured to restrict an operation of the rotation operation unit, wherein
the inner rotating ring includes a plurality of tooth portions, the rotation operation unit includes
a rotation shaft portion rotatable around a shaft center along a radial direction of the dial, and
a drive transmission gear provided on the rotation shaft portion and meshing with the tooth portions to rotate the inner rotating ring,
a plurality of locking portions is formed in the drive transmission gear at different positions in a direction around a shaft,
the rotation restriction unit includes a lock receiving portion biased toward the locking portion and detachably locked to the locking portion, and
the lock receiving portion restricts rotation of the drive transmission gear by being locked to the locking portion.

2. The timepiece according to claim 1, wherein
the locking portion is formed in a convex shape protruding outward in a radial direction of the drive transmission gear, and
the lock receiving portion has a receiving recess to be engaged with the locking portion in a concave-convex manner.

3. The timepiece according to claim 1, wherein
the rotation restriction unit further includes a biasing unit configured to bias the lock receiving portion toward the locking portion by a bending elastic force.

4. The timepiece according to claim 1, wherein
the number of the locking portions is the same as that of driving teeth of the drive transmission gear, and
the positions of the locking portions in the direction around the shaft are positions corresponding to the driving teeth.

5. The timepiece according to claim 2, wherein
the number of the locking portions is the same as that of driving teeth of the drive transmission gear, and
the positions of the locking portions in the direction around the shaft are positions corresponding to the driving teeth.

6. The timepiece according to claim 3, wherein
the number of the locking portions is the same as that of driving teeth of the drive transmission gear, and
the positions of the locking portions in the direction around the shaft are positions corresponding to the driving teeth.

7. The timepiece according to claim 1, wherein
the locking portion is a flat portion formed on the drive transmission gear, and
the lock receiving portion is locked to the flat portion by surface contact.

8. The timepiece according to claim 1, wherein
the locking portions are driving teeth formed on the drive transmission gear to mesh with the tooth portions of the inner rotating ring, and
the lock receiving portion is engaged with the driving teeth in a concave-convex manner.
